(19) United States
(12) Patent Application Publication
(10) Pub. No.: US 2024/0242296 A1
(43) Pub. Date: Jul. 18, 2024

(54) DEVICE FOR PREDICTION PURPOSE OF STAY AND METHOD FOR PREDICTING PURPOSE OF STAY

(71) Applicant: SK TELECOM CO., LTD., Seoul (KR)

(72) Inventors: Ga In HAN, Seoul (KR); Min Hyok BANG, Seoul (KR); Hong Beom AHN, Seoul (KR); Hee Jung YANG, Seoul (KR); Yong Doo LEE, Seoul (KR); Kyong Jin JO, Seoul (KR); Yoon Young CHOI, Seoul (KR)

(21) Appl. No.: 18/559,640

(22) PCT Filed: Jun. 2, 2022
(86) PCT No.: PCT/KR2022/007826

§ 371 Date: Nov. 8, 2023

(30) Foreign Application Priority Data
Jun. 2, 2021 (KR) 10-2021-0071641

(51) Int. Cl. G06Q 50/10; G06F 16/29

(52) U.S. Cl. CPC G06Q 50/10; G06F 16/29

(57) ABSTRACT

The present disclosure provides a method for realizing a new type of stay purpose estimation technology that can estimate the purpose of a user's stay regardless of a label data, departing from a method which predetermines a label data in order to estimate a stay purpose.

### TECHNICAL FIELD

The present disclosure relates to location intelligence technology and, more particularly, to a technology for estimating a stay purpose with respect to a user's location.

The present application claims priority to KR Application No. 10-2021-0071641, filed on Jun. 2, 2021, and all contents of the application are incorporated herein by reference for all purposes.

### BACKGROUND ART

Location intelligence is a technology of deriving spatial insights from location data. Location intelligence technology goes beyond simply expressing data on a map and seeks to integrate business and social phenomena with location data.

In other words, location intelligence is a technology that enables business benefits to be obtained based on spatial understanding of when, where, and why something happens.

Examples of the use of a location intelligence technology include services such as customer-targeted marketing based on local information and behavioral patterns, and promotional marketing using user location information, store location information, and competitor location information.

In other words, from an enterprise perspective, the location intelligence technology may be used to develop and provide various services that can optimize customer experience, business decision-making, and operations by managing, analyzing and executing location data.

In various services using location intelligence technology, when a user stays in a specific location (place), a stay purpose is estimated and optimized services are provided based on the stay purpose.

An existing stay purpose estimation method is a method for pre-storing/preconfiguring information that will be used as a label data for a stay purpose, such as a home address or a workplace address, and in case that a user's location is close to an address of the label data, estimating the stay purpose to be “residential” when the address is a home address or “business” when the address is a workplace address.

However, the existing stay purpose estimation method have a limitation in that the method can estimate a stay purpose only with respect to a location with a predetermined label data, but cannot estimate a stay purpose with respect to a location with no label data.

Accordingly, an aspect of the present disclosure is to propose a new type of stay purpose estimation technology that can estimate the purpose of a user's stay even with respect to a location with no label data, unlike the existing method which predetermines a label data.

### DISCLOSURE OF INVENTION

### Technical Problem

Accordingly, a technical task of the present disclosure is to realize a new type of stay purpose estimation technology that can estimate the purpose of a user's stay regardless of a label data, unlike the existing method which predetermines a label data.

### Solution to Problem

According to the present disclosure, a stay purpose estimation device includes a stay location identification unit configured to identify a stay location of a user, a grid identification unit configured to identify a grid of the stay location as a stay grid in a grid system that divides a target region into a plurality of grids, and an estimation unit configured to estimate the user's stay purpose, based on use-specific areas of buildings included in the stay grid.

Specifically, the grid identification unit may be configured to specify a resolution of the grid system, based on an error range of location information used to identify the user's stay location, and may be configured to identify, as the stay grid, a grid to which the latitude/longitude of the stay location belongs in the grid system having the specified resolution.

Specifically, the resolution of the grid system may be specified to be lower as the error range of the location information is larger.

Specifically, the estimation unit may be configured to identify use of building included in the stay grid, and to determine, based on the use-specific areas obtained by summing areas of a building with each use, a specific use with a largest area as a primary use of the stay grid.

Specifically, when a specific building exists in the stay grid and other grids, an area of the specific building used to determine the use-specific areas may be a gross floor area of the specific building or a gross floor area division value allocated to the stay grid among gross floor area division values, wherein the gross floor area division values may be allocated to each of grids by dividing the gross floor area of the specific building according to proportion in which the specific building exists in the each of the grids.

Specifically, the estimation unit may be configured to use the gross floor area or the gross floor area division values of the specific building based on a use of the specific building, when the use-specific areas is determined.

Specifically, the estimation unit may be configured to estimate the user's stay purpose by using the primary use of the stay grid and a stay start time and stay duration at the stay location.

According to the present disclosure, a stay purpose estimation method includes a stay location identification operation of identifying a stay location of a user, a grid identification operation of identifying a grid of the stay location as a stay grid in a grid system that divides a target region into a plurality of grids, and an estimation operation of estimating the user's stay purpose, based on use-specific areas of buildings included in the stay grid.

Specifically, the grid identification operation may further comprise specifying a resolution of the grid system, based on an error range of location information used to identify the user's stay location; and identifying, as the stay grid, a grid to which the latitude/longitude of the stay location belongs in the grid system having the specified resolution.

Specifically, the resolution of the grid system may be specified to be lower as the error range of the location information is larger.

Specifically, the estimation operation may further comprise identifying use of a building included in the stay grid, determining, based on the use-specific areas obtained by summing area of building with each use, a specific use with a largest area as a primary use of the stay grid, and estimating the user's stay purpose by using the primary use of the stay grid and a stay start time and stay duration at the stay location.

### Advantageous Effects of Invention

The present disclosure may realize a new type of stay purpose estimation technology that can reliably estimate a stay purpose with respect to a user's location regardless of a label data.

Therefore, the present disclosure may be expected to accurately estimate the user's stay purpose even in a location with no label data, and furthermore, to improve the accuracy of various services based on the accurately estimated stay purpose.

### BRIEF DESCRIPTION OF DRAWINGS

FIGS. 1 and 2 are exemplary diagrams illustrating a grid system and a spatial join of grid system/geospatial data, used in the present disclosure.

FIG. 3 is a block diagram illustrating a configuration of a stay purpose estimation device according to an embodiment of the present disclosure.

FIG. 4 is an exemplary table to illustrate the concept of resolution of a grid system used in the present disclosure.

FIG. 5 is an exemplary diagram illustrating a method for calculating use-specific areas of a stay grid proposed by the present disclosure.

FIG. 6 is a flowchart illustrating the flow of operation of a stay purpose estimation method according to an embodiment of the present disclosure.

### BEST MODE FOR CARRYING OUT THE INVENTION

Hereinafter, various embodiments of the present disclosure will be described with reference to the accompanying drawings.

The present disclosure relates to a technology for estimating a stay purpose with respect to a user's location.

Location intelligence is a technology of deriving spatial insights from location data, and goes beyond simple data visualization on maps, to integrating business and societal phenomena with location and analyzing the location data.

In other words, location intelligence is a technology that enables business benefits to be obtained based on spatial understanding of when, where, and why something happens.

Examples of the use of a location intelligence technology include services such as customer-targeted marketing based on local information and behavioral patterns, and promotional marketing using user location information, store location information, and competitor location information.

In other words, from an enterprise perspective, the location intelligence technology may be used to manage, analyze, and execute location data, thereby developing/providing various services that can optimize customer experience, business decision-making, and operations.

In the various services using location intelligence technology, when a user stays in a specific location (place), a stay purpose may be estimated and optimized services may be provided based on the stay purpose.

The existing stay purpose estimation method is a method for pre-storing/preconfiguring information that will be used as a label data for a stay purpose, such as a home address or a workplace address, and in case that a user's location is close to an address of the label data, estimating the stay purpose to be “residential” when the address is a home address or “business” when the address is a workplace address.

However, the existing stay purpose estimation method have a limitation in that the method can estimate a stay purpose only with respect to a location with a predetermined label data, but cannot estimate a stay purpose with respect to a location with no label data.

Accordingly, an aspect of the present disclosure is to propose a new type of stay purpose estimation technology that can estimate a user's stay purpose with respect to a location with no label data, departing from the existing method which predetermines a label data.

In particular, an aspect of the present disclosure is to realize a technology that can estimate the purpose of a user's stay with high reliability through a dynamic grid resolution application method based on the accuracy of a stay location or through a use-specific area calculation method that can divide the influence of building use within a stay grid.

Before describing the present disclosure in detail, two technologies utilized in the present disclosure, a grid system and a spatial join of grid system/geospatial data, will be described.

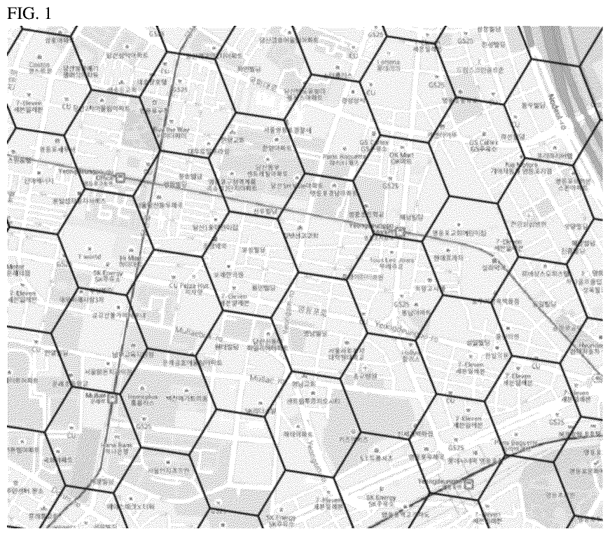

First, a grid system will be described with reference to FIG. 1.

A grid system generally refers to a technology for dividing a surface or a space vertically and horizontally. In a grid system, in spatial analysis, a target region is evenly divided into units of grids, and each grid is given a unique ID, which can be used for spatial indexing.

The grid system is an essential element technology that is fundamental to a spatial join to be described next.

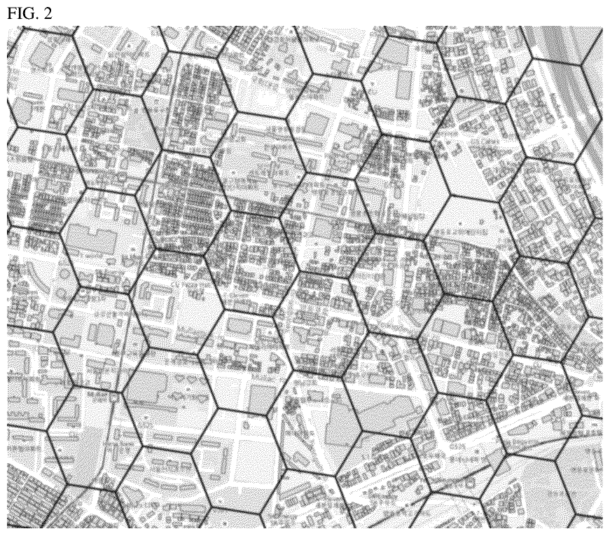

A spatial join of grid system/geospatial data will be described with reference to FIG. 2.

In a grid system, each grid can be given a unique ID. However, there is no numeric common column that allows this ID to be linked with geospatial data such as buildings, roads, subway, and bus routes within the grid, thus leading to the emergence of a spatial join.

In other words, a spatial join refers to a technique for using geometry information to combine grids and geospatial data, assuming that it is known that specific geospatial data exists within a specific grid.

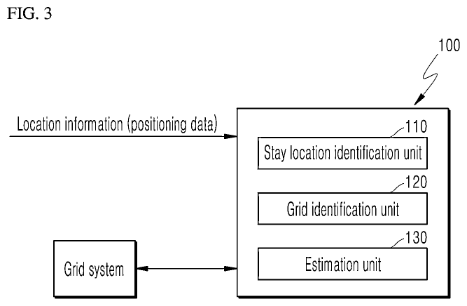

Hereinafter, a stay purpose estimation device 100 for realizing the technology proposed by the present disclosure will be described in detail with reference to FIG. 3.

The stay purpose estimation device 100 realizes a technology that can reliably estimate a stay purpose with respect to a user's location regardless of a label data, that is, the technology proposed by the present disclosure.

As illustrated in FIG. 3, the stay purpose estimation device 100 proposed in the present disclosure includes a stay location identification unit 110, a grid identification unit 120, and an estimation unit 130.

All or at least some of the elements of the stay purpose estimation device 100 may be implemented in the form of hardware modules or software modules, or in a combination of hardware and software modules.

Here, software modules may be understood as instructions which are executed by, for example, a processor configured to control calculation in the stay purpose estimation device 100, and the instructions may be stored in a memory in the stay purpose estimation device 100.

In the end, the stay purpose estimation device 100 according to an embodiment of the present disclosure realizes the technology proposed by the present disclosure, that is, a technology that can reliably estimate a stay purpose with respect to a user's location regardless of a label data through the aforementioned elements.

First, briefly describing the present disclosure, the stay purpose estimation device 100 of the present disclosure is characterized by implementing a technology that can identify a stay location of a user (a terminal) and estimating a stay purpose with respect to the stay location regardless of the presence or absence of a label data for the stay location by estimating the stay purpose based on a determined primary use of a grid of the stay location (hereinafter, a stay grid).

Particularly, in the present disclosure, in identifying the stay grid of the stay location in a grid system, a grid resolution may be dynamically determined and applied based on the accuracy of the stay location, thereby maximizing the use of location information (e.g., positioning data) used to identify the stay location despite limitations of the location information.

In addition, the present disclosure implements a use-specific area calculation method for dividing the influence of a building within a stay grid in determining the primary use of the stay grid, thereby enabling a more reliable estimation of a user's stay purpose.

Hereinafter, a more detailed description will be made of each element in the stay purpose estimation device 100 for realizing the above-described features.

As illustrated in FIG. 3, the stay purpose estimation device 100 of the present disclosure may receive location information (e.g., positioning data) of a user (terminal) and may use the location information to perform stay purpose estimation that will be described below. Here, the user (the terminal) corresponds to a target for which a stay purpose is to be estimated.

Furthermore, the stay purpose estimation device 100 of the present disclosure, in conjunction with a grid system, may evenly divides a target region designated for stay purpose estimation into units of grids, may receive or retrieve grid data in which each grid is given a unique ID, and may utilize the grid data to perform the stay purpose estimation that will be described below.

The stay location identification unit 110 is responsible for identifying the user's stay location.

In the present disclosure, the location information (e.g., the positioning data) of the user (the terminal) for which a stay purpose is to be estimated may be received periodically or nonperiodically.

In the present disclosure, pieces of location information, among the received location information (e.g., positioning data), which fall within a predetermined range and can be considered as the same location over a predetermined time (e.g., 30 minutes) may be grouped into a stay data group.

The stay location identification unit 110 may calculate an average of the latitude/longitude coordinates of the pieces of location information (e.g., the positioning data) grouped into the stay data group, and may identify the calculated average of the latitude/longitude coordinates as the user's stay location.

The grid identification unit 120 is responsible for identifying a grid of the stay location as a stay grid in the grid system that divides the target region into the units of grids.

Specifically, the grid identification unit 120 may identify, as the stay grid, a grid to which the latitude/longitude of the stay location identified by the stay location identification unit 110 described above (=the average of the latitude/longitude coordinates of the stay data group) belongs in the grid system.

The present disclosure implements a feature of dynamically determining and applying the resolution of the grid system depending on the accuracy of the stay location, before identifying the stay grid of the stay location in the grid system.

In a specific embodiment, the grid identification unit 120 may specify the resolution of the grid system based on an error range of the location information (e.g., the positioning data) used to determine the user's stay location.

In the present disclosure, the average of the latitude/longitude coordinates of the pieces of location information (e.g., the positioning data) grouped into the stay data group is used as the user's stay location.

Thus, in the present disclosure, the magnitude of the difference (error) between the latitude/longitude and the average of the latitude/longitude coordinates of each piece of location information (e.g., the positioning data) in the stay group data affects the accuracy of the stay location.

According to an embodiment, in the present disclosure, the difference (error) between the latitude/longitude of location information (e.g., positioning data) farthest from the stay location, among the pieces of the location information (e.g., the positioning data) in the stay data group, and the latitude/longitude of the stay location may be defined as the error range of the location information (e.g., the positioning data) used to identify the stay location.

According to another embodiment, in the present disclosure, an error average calculated by averaging the difference (error) between the latitude/longitude of each piece of location information (e.g., positioning data) in the stay group data and the latitude/longitude of the stay location may be defined as the error range of the location information (e.g., the positioning data) used to identify the stay location.

In the present disclosure, the smaller the error range of the location information (e.g., the positioning data) defined as described above is, the higher the accuracy of the stay location calculated/confirmed by the pieces of the location information in the stay data group is.

Accordingly, the grid identification unit 120 may specify the resolution of the grid system based on an error range of the location information (e.g., the positioning data) that is directly related to the accuracy of the stay location.

More specifically, the resolution of the grid system may be specified, based on the error range of the location information (e.g., the positioning data), to be lower when the error range is large than when the error range is small.

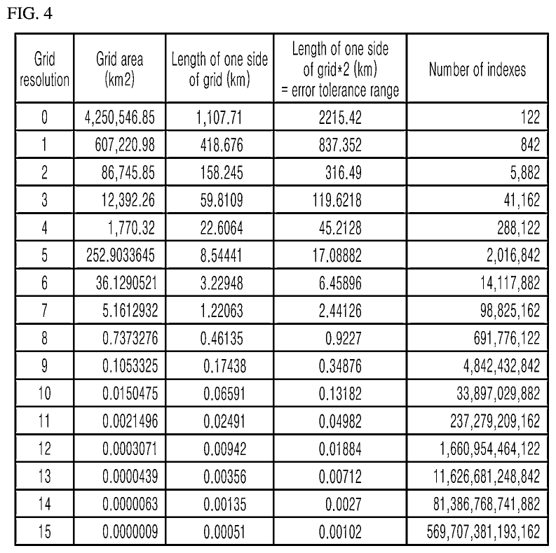

FIG. 4 an exemplary table to illustrate the concept of resolution of a grid system used in the present disclosure.

FIG. 4 shows the relationship between grid size (area, length of a side) and grid resolution by using the H3 grid system as an example. It can be found that as the grid resolution increases, the grid size becomes smaller, enabling more precise subdivisions.

The present disclosure proposes a method for specifying the highest possible grid resolution where the error range of location information (e.g., positioning data) can be accommodated in one grid.

Specifically, for example, assuming the H3 grid system described as an example in FIG. 4, the diameter of a hexagonal grid is twice the length of one side of the grid, and thus, in the present disclosure, as illustrated in the table in FIG. 4, the length of one side of the grid*2 may be defined as an error tolerance range that can accommodate the error range of location information (e.g., positioning data).

Thus, assuming that the location information (e.g., the positioning data) has an error range of 2.3 km, the grid identification unit 120 may specify grid resolution 7 which is the highest level where the error range of 2.3 km can be accommodated in one grid.

When a grid resolution is specified based on the error range of the location information (e.g., the positioning data) as described above, the grid identification unit 120 may identify, as a stay grid, a grid to which the latitude/longitude of a stay location belongs in a grid system with a specific resolution (e.g., grid resolution 7).

Thus, the present disclosure implements a dynamic grid resolution application method that, in identifying a stay grid of a stay location in a grid system, does not unconditionally use a high-resolution grid system, but rather uses a grid system with a resolution dynamically determined based on an error range of location information (e.g., positioning data) that is directly related to the accuracy of the stay location.

In this case, if the accuracy of the stay location is low enough to limit the use of a high-resolution grid, a primary use to be described later may be determined in a large range expressed as a larger grid by lowering the resolution, thus maximizing the use of location information (e.g., positioning data) despite limitations of the location information.

The estimation unit 130 is responsible for estimating a user's stay purpose, based on use-specific areas of buildings included in the stay grid identified by the grid identification unit 120.

Specifically, the estimation unit 130 may identify uses of individual buildings included in the stay grid, and may determine that a specific use occupying a largest area among the use-specific areas obtained by summing areas of the individual building for each identified use is a primary use of the stay grid.

The estimation unit 130 may estimate the user's stay purpose by using the primary use of the stay grid, and a stay start time and stay duration at the stay location.

Hereinafter, the process of determining the primary use of the stay grid will be described in detail.

As described above, the present disclosure utilizes a spatial join of grid system/geospatial data.

In a specific embodiment, in the present disclosure, the special join is used to spatially combine geospatial data in a stay grid with the stay grid.

Thus, in the present disclosure, a join table in which the stay grid and buildings existing therein are matched may be obtained. A use code and gross floor area information of each building are also matched together in the join table.

Accordingly, the estimation unit 130 may identify uses of individual buildings included in the stay grid, based on the join table obtained as a result of the spatial join, and may calculate use-specific areas by summing areas of the individual buildings for each identified use.

The present disclosure may propose, as methods for calculating use-specific areas of a stay grid, the following two methods: a use-specific area calculation method based on gross floor area division values according to existence proportion; and a use-specific area calculation method based on a gross floor area according to building influence.

The difference between the two methods proposed in the present disclosure is how areas of a specific building that exists in a stay grid and other grids are determined and summed when summing areas of individual buildings for each use in order to calculate use-specific areas of the stay grid.

Specifically, according to the present disclosure, the area of a building used in the summation for the use-specific areas of the stay grid may be, in case of a specific building existing in the stay grid and other grids, a gross floor area of the specific building or a gross floor area division value allocated to the stay grid among gross floor area division values allocated to the grids by dividing the gross floor area of the specific building according to the proportion in which the specific building exists in each grid.

The use-specific area calculation method based on gross floor area division values according to existence proportion, among the two methods proposed in the present disclosure, is a method for using gross floor area division values of a specific building to sum areas of individual buildings for each use in order to calculate the use-specific areas of the stay grid.

The use-specific area calculation method based on a gross floor area according to building influence, among the two methods proposed in the present disclosure, is a method for using the gross floor area of a specific building to sum areas of individual buildings for each use in order to calculate the use-specific areas of the stay grid. In this case, the gross floor area of the specific building may be adjusted based on the use influence of the building. i.e., the probability that the user stayed in the building.

Firstly, the use-specific area calculation method based on gross floor area division values according to existence proportion will be described.

The use-specific area calculation method based on gross floor area division values according to an existence proportion is a method in which when a specific building exists in multiple grids including the currently identified stay grid, the probability that a user stayed in the specific building (hereinafter referred to as the use influence of the specific building) is divided by using the proportion in which the building exists in each grid.

Specifically, in the present disclosure, a grid shape file (A) related to a stay grid and a building shape file (B) of geospatial data in the stay grid are located in the same coordinate system to perform spatial joining as described above, and the building shape file (B) is clipped with the grid shape file (A) (a method for cutting one shape in a way that stamps the one shape with the other shape).

Accordingly, in the present disclosure, each building existing in the stay grid, and a use code and gross floor area information of the building may be identified through the spatial joining and the clipping described above, and in particular, the gross floor area of a specific building existing in the stay grid and other grids may be allocated to each grid based on the proportion in which the specific building exists in each grid.

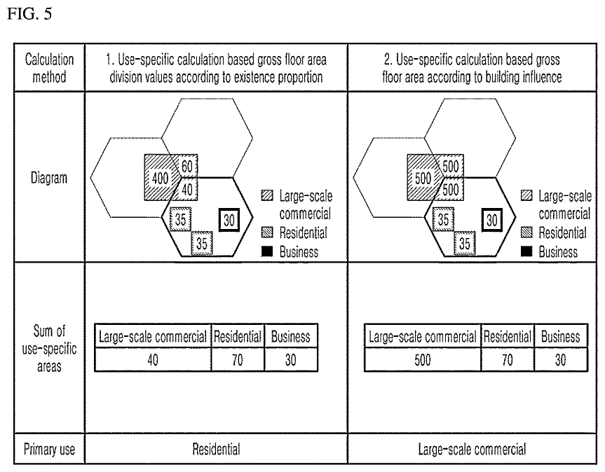

Referring to FIG. 5, in FIG. 5, it is assumed that a specific building for a large commercial use exists in a stay grid (a red grid) and other grids.

The left side of FIG. 5 shows a use-specific area calculation method based on gross floor area division values according to existence proportion.

Looking at the left side of FIG. 5, it can be found that the gross floor area of a specific building existing in a stay grid and other grids is allocated to each of three grids, in which the specific building exists, based on existence proportion.

Accordingly, the estimation unit 130 may identify uses of individual buildings included in the stay grid and calculate use-specific areas by summing areas of the individual buildings for each identified use, wherein with respect to a specific building existing in the stay grid and other grids, the actual gross floor area 500 of the specific building is divided according to the proportion in which the specific building exists in each grid and the summation is performed using a gross floor area division value 40 allocated to the stay grid (the red grid) among gross floor area division values allocated to the grids, respectively.

According to this calculation method, the estimation unit 130 may calculate use-specific areas of the stay grid as large-scale commercial 40, residential 70, and business 30, as illustrated in FIG. 5, and may determine that a residential use which is a specific use 70 occupying the largest area among the use-specific areas is the primary use of the stay grid.

The use-specific area calculation method based on gross floor area division values according to existence proportion may be referred to as a use-specific area method capable of most equitably dividing the influence of the use of a building which overlaps multiple grids.

Secondly, the use-specific area calculation method based on a gross floor area according to building influence is described as follows.

The use-specific area calculation method based on a gross floor area according to building influence is a method in which when a specific building exists in multiple grids including the currently identified stay grid, the probability that a user stayed in the specific building (hereinafter referred to as the use influence of the specific building) is the same in each grid, regardless of the proportion in which the building exists in each grid.

Specifically, in the present disclosure, a grid shape file (A) related to a stay grid and a building shape file (B) of geospatial data in the stay grid are located in the same coordinate system to perform spatial joining as described above.

Accordingly, in the present disclosure, each building existing in the stay grid, and a use code and gross floor area information of the building may be identified through the spatial joining described above.

The right side of FIG. 5 shows a use-specific area calculation method based on a gross floor area according to building influence.

Looking at the right side of FIG. 5, it can be found that the gross floor area of a specific building existing in a stay grid and other grids is equally allocated to three individual grids in which the specific building exists.

In the present disclosure, the gross floor area of the specific building, which is allocated equally to the three individual grids in which the specific building exists, may be adjusted based on the use influence of the building, i.e., the probability that a user stayed in the building.

In other words, in the present disclosure, the gross floor area of a specific building, which is to be used to calculate use-specific areas of a stay grid, may be adjusted based on what is the use of the specific building that exists in the stay grid and other grids.

For example, the actual gross floor area of a specific building, 500, may be used as 500 by applying 100%, 400 by applying 80%, and 600 by applying 120%.

FIG. 5 illustrates an example in which the actual gross floor area of a specific building, 500, is used as 500 by applying 100%, in an embodiment of the use-specific area calculation method based on a gross floor area according to building influence.

Accordingly, the estimation unit 130 may identify uses of individual buildings included in a stay grid and may calculate use-specific areas by summing areas of the individual buildings for each identified use, wherein with respect to a specific building existing in the stay grid and other grids, the summation may be performed using a gross floor area (e.g., 500 for 100%, 400 for 80%, etc.) adjusted based on the use influence of the specific building.

According to this calculation method, the estimation unit 130 may calculate use-specific areas of the stay grid as large-scale commercial 500, residential 70, and business 30, as illustrated in FIG. 5, and may determine that a large-scale commercial use which is a specific use occupying the largest area among the use-specific areas is the primary use of the stay grid.

The above-described use-specific area calculation method based on a gross floor area according to building influence may be referred to as a use-specific area calculation method that can be useful when a building with a use suitable for a stay purpose to be estimated has a significant influence on a corresponding region.

For example, it will be assumed that a stay purpose to be estimated is “shopping”.

When using the use-specific area calculation method based on a gross floor area according to building influence and proposed by the present disclosure, a building for large-scale commercial use may be determined to have the highest influence in the corresponding region, and use-specific areas reflecting a high use influence may be calculated regardless of the proportion in which the building exists in a stay grid for the estimation of a stay purpose.

In a more specific embodiment, when performing the summation for the use-specific areas described above, the estimation unit 130 may select and use a gross floor area division value or (adjusted) gross floor area of a specific building existing in a stay grid and other grids, based on the use of the specific building.

In other words, when performing the summation for the use-specific areas described above, the estimation unit 130 may select a calculation method based on the use of the specific building existing in the stay grid and the other grids.

For example, the estimation unit 130, when performing summation for the use-specific areas described above, may select the use-specific area calculation method based on gross floor area division values according to existence proportion with respect to a specific building existing in a stay grid and other grids in case that the use of the specific building is a general use (e.g., residential use, business use, etc.) in terms of a purpose (e.g., shopping) for estimating a stay purpose, and may use/sum the gross floor area division values of the specific building accordingly.

The estimation unit 130, when performing summation for the above-mentioned use-specific areas, may select the use-specific area calculation method based on a gross floor area according to building influence with respect to a specific building existing in a stay grid and other grids in case that the use of the specific building is a predetermined use (e.g., a large-scale commercial use, etc.) in terms of a purpose (e.g., shopping) for estimating a stay purpose, and may use/sum the gross floor area (e.g., 100%, 80%, 120%, etc. of the actual gross floor area) of the specific building accordingly.

Accordingly, in the various embodiments described above, the estimation unit 130 may determine that a specific use occupying the largest area among use-specific areas obtained by summing areas of individual buildings in a stay grid for each use is the primary use of the stay grid.

Furthermore, in the present disclosure, even in the use-specific area calculation method based on gross floor area division values according to existence proportion, before dividing the gross floor area of a specific building based on the proportion in which a specific building exists in each grid, the gross floor area to be divided may be adjusted based on the use influence of the building, that is, the probability that the user stayed in the building.

In other words, in the present disclosure, based on what is the use of a specific building that exists in a stay grid and other grids, the gross floor area of the specific building, which is to be used/divided to calculate use-specific areas of the stay grid, can be adjusted.

For example, the actual gross floor area of a specific building, 500, may be used as 500 by applying 100%, 400 by applying 80%, and 600 by applying 120%.

In this case, the estimation unit 130 may identify uses of individual buildings included in a stay grid and may calculate use-specific areas by summing areas of the individual buildings for each identified use, wherein with respect to a specific building existing in the stay grid and other grids, a gross floor area (e.g., 500 for 100%, 400 for 80%, etc.) adjusted based on the use influence of the specific building may be divided based on the proportion in which the specific building exists in each grid, and the summation may be performed using a gross floor area division value (e.g. 40 for 100%, 32 for 80%, etc.) allocated to the stay grid (a red grid) among gross floor area division values allocated to the grids, respectively.

In the present disclosure, the primary use of the stay grid, determined as described above, is used as supporting data for estimating a stay purpose with respect to a location with no label data.

When the primary use which serves as the supporting data for estimating a stay purpose with respect to a stay grid corresponding to the location with no label data is determined as described above, the estimation unit 130 may estimate a user's stay purpose by using the determined primary use of the stay grid, as well as a stay start time and stay duration at the stay location.

In a specific embodiment, the estimation unit 130 may estimate a stay purpose to be “home stay” if the stay start time is after 7 PM, the stay duration is equal to or more than 8 hours, and the primary use of the stay grid is “residential”.

In another embodiment, the estimation unit 130 may estimate the stay purpose to be “company stay” if the stay start time is after 8 AM, the stay duration is equal to or more than 8 hours, and the primary use of the stay grid is “business”.

In another embodiment, the estimation unit 130 may estimate the stay purpose to be “shopping” if the stay start time is between 10:00 and 22:00, which are typical business hours of retail facilities, the stay duration is equal to or more than one hour, and the primary use of the stay grid is “large-scale commercial”.

The present disclosure is not limited to the above embodiments, and the user's stay purpose may be estimated based on various estimation policies established using the primary use of a stay grid, and a stay start time and stay duration at a stay location.

As described above, the present disclosure realizes a technology that can estimate a stay purpose with respect to a user (terminal)'s location regardless of a label data, by identifying a stay location of the user, determining a primary use to be used as supporting data for estimating a stay purpose with respect to a grid of the stay location (hereinafter, a stay grid), and estimating the stay purpose based on the primary use.

Particularly, in the present disclosure, in identifying the stay grid of the stay location in a grid system, a grid resolution may be dynamically determined and applied based on the accuracy of the stay location, thereby maximizing the use of location information (e.g., positioning data) used to identify the stay location despite limitations of the location information.

In addition, the present disclosure implements a use-specific area calculation method for dividing the influence of a building within a stay grid in determining the primary use of the stay grid, thereby enabling a more reliable estimation of a user's stay purpose.

Therefore, the present disclosure may be expected to accurately estimate the user's stay purpose even in a location with no label data, and furthermore, to improve the accuracy of various services based on the accurately estimated stay purpose.

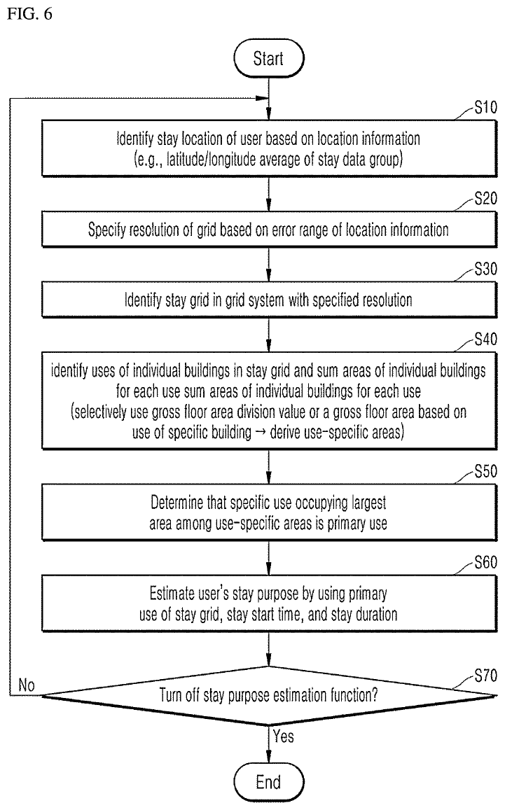

Hereinafter, the flow of operation of a stay purpose estimation method according to an embodiment of the present disclosure will be described with reference to FIG. 6.

For convenience of description, the stay purpose estimation device 100 will be described as an entity for performing the stay purpose estimation method of the present disclosure.

According to the stay purpose estimation method of the present disclosure, the stay purpose estimation device 100 may periodically or nonperiodically receive location information (e.g., positioning data) of a user (a terminal) for which a stay purpose is to be estimated, and identify a stay location of the user based on the location information (S10).

In a specific embodiment, the stay purpose estimation device 100 may group, into a stay data group, pieces of location information, among the periodically or nonperiodically received location information (e.g., positioning data) of the user (the terminal), which fall within a predetermined range and can be considered as the same location over a predetermined time (e.g., 30 minutes).

The stay purpose estimation device 100 may calculate an average of the latitude/longitude coordinates of the pieces of location information (e.g., the positioning data) grouped into the stay data group, and may identify the calculated average of the latitude/longitude coordinates as the user's stay location.

Then, according to the stay purpose estimation method of the present disclosure, the stay purpose estimation device 100 specifies a resolution of the grid system based on an error range of location information used to identify the user's stay location (S20).

According to an embodiment, in the present disclosure, the difference (error) between the latitude/longitude of location information (e.g., positioning data) farthest from the stay location, among the pieces of the location information (e.g., the positioning data) in the stay data group, and the latitude/longitude of the stay location may be defined as the error range of the location information (e.g., the positioning data) used to identify the stay location.

According to another embodiment, in the present disclosure, an error average calculated by averaging the difference (error) between the latitude/longitude of each piece of location information (e.g., positioning data) in the stay group data and the latitude/longitude of the stay location may be defined as the error range of the location information (e.g., the positioning data) used to identify the stay location.

Accordingly, the stay purpose estimation device 100 may specify the resolution of the grid system based on an error range of the location information (e.g., the positioning data) that is directly related to the accuracy of the stay location.

More specifically, the stay purpose estimation device 100 may specify, based on the error range of the location information (e.g., the positioning data), the resolution of the grid system to be lower when the error range is large than when the error range is small.

According to the stay purpose estimation method of the present disclosure, when the grid resolution is specified based on the error range of the location information (e.g., the positioning data) as described above (S20), the stay purpose estimation device 100 may identify, as a stay grid, a grid to which the latitude/longitude of a stay location belongs in a grid system with a specific resolution (e.g., grid resolution 7) (S30).

Thus, the present disclosure implements a dynamic grid resolution application method that, in identifying a stay grid of a stay location in a grid system, does not unconditionally use a high-resolution grid system, but rather uses a grid system with a resolution dynamically determined based on an error range of location information (e.g., positioning data) that is directly related to the accuracy of the stay location.

In this case, if the accuracy of the stay location is low enough to limit the use of a high-resolution grid, a primary use to be described later may be determined in a large range expressed as a larger grid by lowering the resolution, thus maximizing the use of location information (e.g., positioning data) despite limitations of the location information.

According to the stay purpose estimation method of the present disclosure, the stay purpose estimation device 100 estimates the user's stay purpose (S40 to S60), based on use-specific areas of buildings included in the stay grid identified in operation S30.

Specifically, the stay purpose estimation device 100 may identify uses of individual buildings included in the stay grid and may derive use-specific areas by summing areas of the individual buildings for each identified use (S40).

In a specific embodiment, in the present disclosure, a join table in which the stay grid and buildings existing therein are matched may be obtained by spatially combining geospatial data in the stay grid with the stay grid through a spatial join. A use code and gross floor area information of each building are also matched together in the join table.

Accordingly, the stay purpose estimation device 100 may identify uses of individual buildings included in the stay grid, based on the join table obtained as a result of the spatial join, and may calculate use-specific areas by summing areas of the individual buildings for each identified use.

When performing the summation for the above-described use-specific areas, the stay purpose estimation device 100 may select and use, based on the use of a specific building existing in the stay grid and other grids, a gross floor area division value or a gross floor area (e.g., 100%, 80%, 120%, etc. of an actual gross floor area) of the specific building.

The present disclosure proposes, as methods for calculating use-specific areas of a stay grid, the following two methods: a use-specific area calculation method based on gross floor area division values according to existence proportion; and a use-specific area calculation method based on a gross floor area according to building influence.

Referring to FIG. 5, the use-specific area calculation method based on gross floor area division values according to existence proportion is a method for identifying uses of individual buildings included in the stay grid and calculating use-specific areas by summing areas of the individual buildings for each identified use, wherein with respect to a specific building existing in the stay grid and other grids, the actual gross floor area 500 of the specific building are divided according to the proportion in which the specific building exists in each grid and the summation is performed using a gross floor area division value 40 allocated to the stay grid (the red grid) among gross floor area division values allocated to the grids, respectively.

In addition, referring to FIG. 5, the use-specific area calculation method based on a gross floor area according to building influence is a method for identifying uses of individual buildings included in the stay grid and calculating use-specific areas by summing areas of the individual buildings for each identified use, wherein with respect to a specific building existing in the stay grid and other grids, the summation is performed using the same gross floor area (e.g., 100%, 80%, 120%, etc. of an actual gross floor area) regardless of the proportion in which the specific building exists in each grid.

Thus, when performing the summation for the use-specific areas described above, the stay purpose estimation device 100 may select a calculation method based on the use of the specific building existing in the stay grid and the other grids.

For example, the stay purpose estimation device 100, when performing the summation for the use-specific areas described above, may select the use-specific area calculation method based on gross floor area division values according to existence proportion with respect to a specific building existing in the stay grid and other grids in case that the use of the specific building is a general use (e.g., residential use, business use, etc.) in terms of a purpose (e.g., shopping) for estimating a stay purpose, and may use/sum the gross floor area division values of the specific building accordingly.

The stay purpose estimation device 100, when performing the summation for the use-specific areas described above, may select the use-specific area calculation method based on a gross floor area according to building influence with respect to a specific building existing in the stay grid and other grids in case that the use of the specific building is a predetermined use (e.g., a large-scale commercial use, etc.) in terms of a purpose (e.g., shopping) for estimating a stay purpose, and may use/sum the gross floor area (e.g., 100%, 80%, 120%, etc. of the actual gross floor area) of the specific building accordingly.

According to the stay purpose estimation method of the present disclosure, the stay purpose estimation device 100 may determine that a specific use occupying the largest area among the use-specific areas of the stay grid derived in operation S40 is the primary use of the stay grid (S50).

In the present disclosure, the primary use of the stay grid, determined as described above, is used as supporting data for estimating a stay purpose with respect to a location with no label data.

According to the stay purpose estimation method of the present disclosure, when the primary use which serves as the supporting data for estimating a stay purpose with respect to a stay grid corresponding to the location with no label data is determined as described above (S50), the stay purpose estimation device 100 may estimate a user's stay purpose by using the determined primary use of the stay grid, as well as a stay start time and stay duration at the stay location (S60).

In a specific embodiment, the stay purpose estimation device 100 may estimate the stay purpose to be “home stay” if the stay start time is after 7 PM, the stay duration is equal to or more than 8 hours, and the primary use of the stay grid is “residential”.

In another embodiment, the stay purpose estimation device 100 may estimate the stay purpose to be “company stay” if the stay start time is after 8 AM, the stay duration is equal to or more than 8 hours, and the primary use of the stay grid is “business”.

In another embodiment, the stay purpose estimation device 100 may estimate the stay purpose to be “shopping” if the stay start time is between 10:00 and 22:00, which are typical business hours of retail facilities, the stay duration is equal to or more than one hour, and the primary use of the stay grid is “large-scale commercial”.

The present disclosure is not limited to the above embodiments, and the user's stay purpose may be estimated based on various estimation policies established using the primary use of a stay grid, and a stay start time and stay duration at a stay location.

As described above, according to the stay purpose estimation method of the present disclosure, the stay purpose estimation device 100 may estimate a stay purpose with respect to the user's stay location by repeatedly performing operation S10 and subsequent operations until a stay purpose estimation function is turned off (S70 No).

As described above, the present disclosure realizes a technology that can estimate a stay purpose with respect to a user (terminal)'s location regardless of a label data by identifying a stay location of the user, determining a primary use to be used as supporting data for estimating a stay purpose with respect to a grid of the stay location (hereinafter, a stay grid), and estimating the stay purpose based on the primary use.

Therefore, the present disclosure may be expected to accurately estimate the user's stay purpose even in a location with no label data, and furthermore, to improve the accuracy of various services based on the accurately estimated stay purpose.

A stay purpose estimation method according to an embodiment of the present disclosure may be implemented in the form of a program command that can be executed through various computer means, and may be recorded in a computer-readable medium. The computer-readable medium may include program commands, data files, data structures, etc., singly or in combination. The program commands recorded in the medium may be specifically designed and configured for the present disclosure or may be known and available to those skilled in the art of computer software. Examples of computer-readable recording media include magnetic media such as a hard disk, a floppy disk, and a magnetic tape, optical media such as a CD-ROM and a DVD, magneto-optical media such as floptical disks, and hardware devices specifically configured to store and execute program commands, such as ROM, RAM, flash memory, and the like. Examples of the program commands include high-class language codes, which can be executed in a computer by using an interpreter, as well as machine codes made by a compiler. The aforementioned hardware devices may be configured to operate as one or more software modules in order to perform the operation of the present disclosure, and vice versa.

Although the present disclosure has been described in detail with reference to various embodiments, the present disclosure is not limited to the above embodiments. Those skilled in the art to which the present disclosure belongs will understand that the technical idea of the present disclosure extends to various modifications or modifications without departing from the subject matter of the present disclosure as claimed in the following claims.

1. A stay purpose estimation device comprising:
a stay location identification unit configured to identify a stay location of a user;
a grid identification unit configured to identify a grid of the stay location as a stay grid in a grid system that divides a target region into a plurality of grids; and
an estimation unit configured to estimate the user's stay purpose, based on use-specific areas of buildings included in the stay grid.

2. The stay purpose estimation device of claim 1, wherein the grid identification unit is configured to:
specify a resolution of the grid system, based on an error range of location information used to identify the user's stay location; and
identify, as the stay grid, a grid to which the latitude/longitude of the stay location belongs in the grid system having the specified resolution.

3. The stay purpose estimation device of claim 2, wherein the resolution of the grid system is specified to be lower as the error range of the location information is larger.

4. The stay purpose estimation device of claim 1, wherein the estimation unit is configured to:
identify use of a building included in the stay grid; and
determine, based on the use-specific areas obtained by summing area of building with each use, a specific use with a largest area as a primary use of the stay grid.

5. The stay purpose estimation device of claim 4, wherein when a specific building exists in the stay grid and other grids, an area of the specific building used to determine the use-specific areas is a gross floor area of the specific building or a gross floor area division value allocated to the stay grid among gross floor area division values,
wherein the gross floor area division values is allocated to each of grids by dividing the gross floor area of the specific building according to proportion in which the specific building exists in the each of the grids.

6. The stay purpose estimation device of claim 5, wherein the estimation unit is configured to use the gross floor area or the gross floor area division values of the specific building based on a use of the specific building, when the use-specific areas is determined.

7. The stay purpose estimation device of claim 4, wherein the estimation unit is configured to estimate the user's stay purpose by using the primary use of the stay grid and a stay start time and stay duration at the stay location.

8. A stay purpose estimation method comprising:
identifying a stay location of a user;
identifying a grid of the stay location as a stay grid in a grid system that divides a target region into a plurality of grids; and
estimating the user's stay purpose, based on use-specific areas of buildings included in the stay grid.

9. The stay purpose estimation method of claim 8, wherein the identifying further comprises:
specifying a resolution of the grid system, based on an error range of location information used to identify the user's stay location; and
identifying, as the stay grid, a grid to which the latitude/longitude of the stay location belongs in the grid system having the specified resolution.

10. The stay purpose estimation method of claim 9, wherein the resolution of the grid system is specified to be lower as the error range of the location information is larger.

11. The stay purpose estimation method of claim 8, wherein the estimating further comprises:
identifying use of a building included in the stay grid;
determining, based on the use-specific areas obtained by summing area of building with each use, a specific use with a largest area as a primary use of the stay grid, and
estimating the user's stay purpose by using the primary use of the stay grid and a stay start time and stay duration at the stay location.

12. A computer program coupled to hardware and stored in a medium in order to execute each operation performed in the method of claim 8.
